(19) United States
(12) Patent Application Publication
(10) Pub. No.: US 2013/0043290 A1
(43) Pub. Date: Feb. 21, 2013

(54) DOUBLE DIN AUTOMOBILE MOUNT FOR TABLET COMPUTERS

(71) Applicants: JEREMY CARL PRATER, Oxnard, CA (US); Kasidy Alves, Oxnard, CA (US); Eleuterio Ted Lopez, Oxnard, CA (US)

(72) Inventors: JEREMY CARL PRATER, Oxnard, CA (US); Kasidy Alves, Oxnard, CA (US); Eleuterio Ted Lopez, Oxnard, CA (US)

(73) Assignee: Scosche Industries, Inc., Oxnard, CA (US)

(21) Appl. No.: 13/354,259

(22) Filed: Jan. 19, 2012

Related U.S. Application Data
(60) Provisional application No. 61/524,240, filed on Aug. 16, 2011.

(51) Int. Cl. B60R 11/00; B23P 17/04

(52) U.S. Cl. 224/567; 29/428

(57) ABSTRACT

A tablet mount is disclosed herein having an insert configured for mounting in a receptacle, the insert having two plates, each plate having a set of openings matched to a plurality amounting holes, the two plates being parallel to each other; a face plate coupled to the insert, the face plate having an adjustable support extending therefrom; and a tablet holder coupled to the adjustable support. A method of using the tablet mount is also disclosed herein.

### CROSS-REFERENCE TO RELATED APPLICATION

This Application claims priority from U.S. Provisional Application Ser. No. 61/524,240, filed Aug. 16, 2011, the contents of which are hereby incorporated by reference herein in their entirety.

### FIELD

The present disclosure relates to electronic device mounts, and, more particularly, to a double DIN automobile mount for tablet computers.

### BACKGROUND

Tablet computers are quickly becoming popular electronic devices for accessing the World Wide Web, reading news and periodicals, enjoying multimedia entertainments such as music, videos and pictures, and accessing data and other references. For many applications, tablet computers and other portable computing devices significantly facilitate the access to data and programs, especially in mobile applications where access to information on the move is desirable. As a result, such computing devices offer value, not only because of the data that they enable, but also because of the access to data that they offer.

The access to data and programs provided by tablet computers is especially beneficial in application such as automobile computing. For example, it is useful for drivers to access to navigation data and directions while seeking a particular destination, Further, being able to play music and other entertainment while in the car is desirable. However, the mounting of tablet computers pose a challenge as they have a form factor that is not small enough to easily affix in a vehicle. Further, because of concerns with theft, the tablet computer should not be left in an unattended vehicle, Also, it would be desirable for the user to be able to remove the tablet computer and use it outside of the vehicle.

There is a need, therefore, for a tablet computer holding device or docking station stand that allows the tablet computer to be mounted in a vehicle securely and in a convenient location. There is a need for a method and system that permits a user to control the time or circumstances at which a tablet computer may be physically removed from a suitable location in a vehicle.

### BRIEF DESCRIPTION OF THE DRAWINGS

FIG. 1 is a perspective view of a double DIN-sized tablet mount configured in accordance with one aspect of the invention.

FIG. 2 is a perspective view of the double DIN-sized tablet mount of FIG. 1 configured in accordance with one aspect of the invention, further illustrating an adjustable mechanism for holding the tablet.

FIG. 3 is a perspective view of the double DIN-sized tablet mount of FIG. 1 configured in accordance with one aspect of the invention, further illustrating a second embodiment of an extension shaft.

FIG. 4 is a perspective view of the double DIN-sized tablet mount of FIG. 1 configured in accordance with one aspect of the invention, further illustrating a tablet support.

FIG. 5 is a perspective view of a protective case for the tablet to be used to mount the tablet to the double DIN-sized tablet mount of FIG. 1 configured in accordance with one aspect of the invention,

FIG. 6 is a detail view of the protective case of FIG. 5 configured in accordance with one aspect of the invention, further illustrating a tablet support attachment point.

FIG. 7 is a perspective view of a second embodiment of the double DIN-sized tablet mount of FIG. 1 configured in accordance with one aspect of the invention, further illustrating another embodiment of the adjustable mechanism for holding the tablet.

FIG. 8 is a perspective view of the double DIN-sized tablet mount of FIG. 7 configured in accordance with one aspect of the invention, further illustrating the adjustable mechanism for holding the tablet.

FIG. 9 is a detail view of the double DIN-sized tablet mount of FIG. 7 configured in accordance with one aspect of the invention, further illustrating a retaining clip mechanism.

### DETAILED DESCRIPTION

The disclosed mount is described more fully hereinafter with reference to the accompanying drawings, in which various aspects of a tablet mount are shown. The disclosed mount, however, may be embodied in many different forms and should not be construed as limited by the various aspects of the tablet mount presented herein. The detailed description of the tablet mount is provided below so that this disclosure will be thorough and complete, and will fully convey the scope of the present disclosure to those skilled in the art.

The detailed description may include specific details for illustrating various aspects of a tablet mount. However, it will be apparent to those skilled in the art that the various aspects of the disclosure may be practiced without these specific details. In some instances, well known elements may be shown in block diagram form, or omitted, to avoid obscuring the novel and unobvious concepts presented throughout this disclosure. Further, although the various embodiments may be described in terms of use with a mobile device such as a tablet such as the Apple® iPad®, the described tablet mount may be used for a variety of other tablets or other devices, including laptops, portable computers, cameras, flashlights, global positioning systems (GPS), personal digital assistants (PDA's), multimedia players, portable radios and other similar handheld devices.

Various aspects of a tablet mount may be illustrated by describing components that are coupled together. As used herein, the term “coupled” is used to indicate either a direct connection between two components or, where appropriate, an indirect connection to one another through intervening or intermediate components. In contrast, when a component referred to as being “directly coupled” to another component, there are no intervening elements present.

Relative terms such as “lower” or “bottom” and “upper” or “top” may be used herein to describe one element's relationship to another element illustrated in the drawings. It will be understood that relative terms are intended to encompass different orientations of a tablet mount in addition to the orientation depicted in the drawings. B way of example, if a tablet mount in the drawings is turned over, elements described as being on the “bottom” side of the other elements would then be oriented on the “top” side of the other elements. The term “bottom” can therefore encompass both an orientation of “bottom” and “top” depending on the particular orientation of the apparatus.

Various aspects of a tablet mount may be illustrated with reference to one or more exemplary embodiments. As used herein, the term “exemplary” means “serving as an example, instance, or illustration,” and should not necessarily be construed as preferred or advantageous over other aspects of a tablet mount disclosed herein.

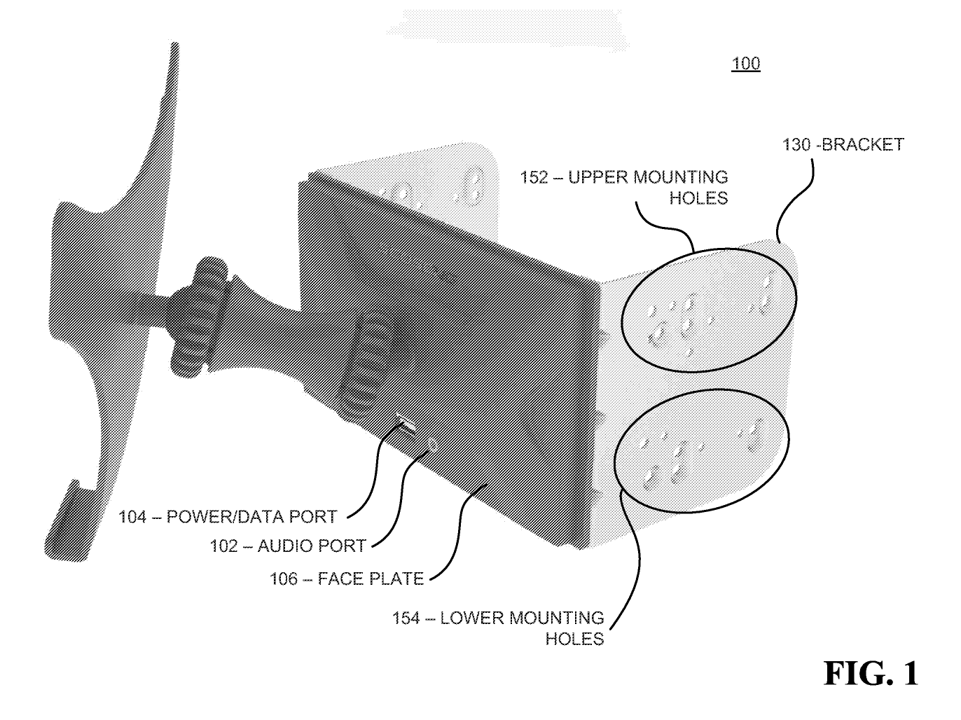

International standard ISO 7736 defines a standard size for car audio head units. The standard was originally established by the German standards body Deutsches Institut für Normung as DIN 75490, and is therefore commonly referred to as the “DIN car radio size”. It was adopted as an international standard in 1984. Bead units generally come in either single DIN (180×50 mm panel) or double DIN (180×100 mm panel) size. The depth is not standardized. The US standard for a DIN radio is 2″×7″ and the Double DIN sized radio is a 4″×7″. The present invention discloses a table mount 100 configured to support a tablet in an automobile interior, The tablet mount 100 is illustrated in FIG. 1, and is configured to fit in a double-DIN-sized opening. The tablet mount 100 includes a face plate 106 having two ports, including a power/data port 104 and an audio port 102. in one embodiment, the power/data port 104 is operable with connectors that are compliant with the Universal Serial Bus (USB) standard. The power/data port 104 may be used to provide power to the tablet by the tablet mount 100 being coupled to a power system of the automobile. In another embodiment, the power/data port 104 may also be used to provide data connectivity to the tablet, such as if the automobile contains electronic devices with which the tablet may communicate. In this latter embodiment, the power/data port 104 will be coupled to a circuit of the automobile to which the electronic devices are also coupled. The various electronic couplings described herein may be approached in a variety of manners, all of which are known to those of ordinary skill in the art.

The face plate 106 is mounted to a bracket 130, To secure the tablet mount 100 to the vehicle, a set of fasteners such as screws may be used to fasten the bracket 130. In one embodiment, as the tablet mount 100 is a double-DIN-sized mount, two set of mounting holes are provided. A set of upper mounting holes 152 and a set of lower mounting holes 154 are each respectively matched to another set of screw holes in the double-DIN support. Thus, in one aspect of the present invention, the tablet mount 100 replaces a double-DIN-sized car stereo or two separate DIN-sized devices in the dashboard of the vehicle.

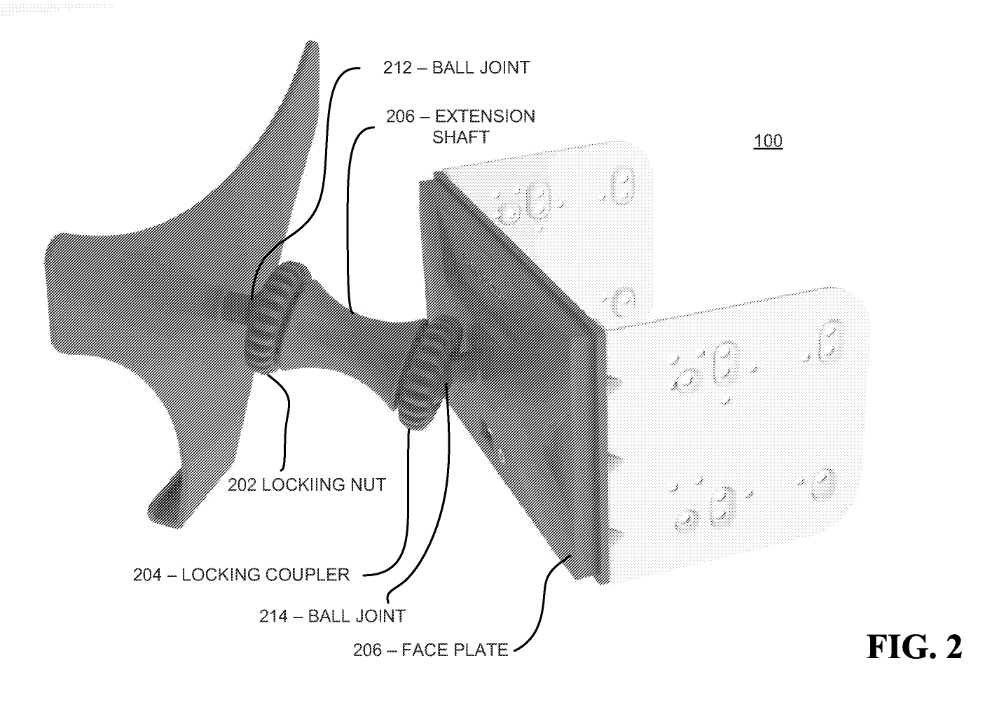

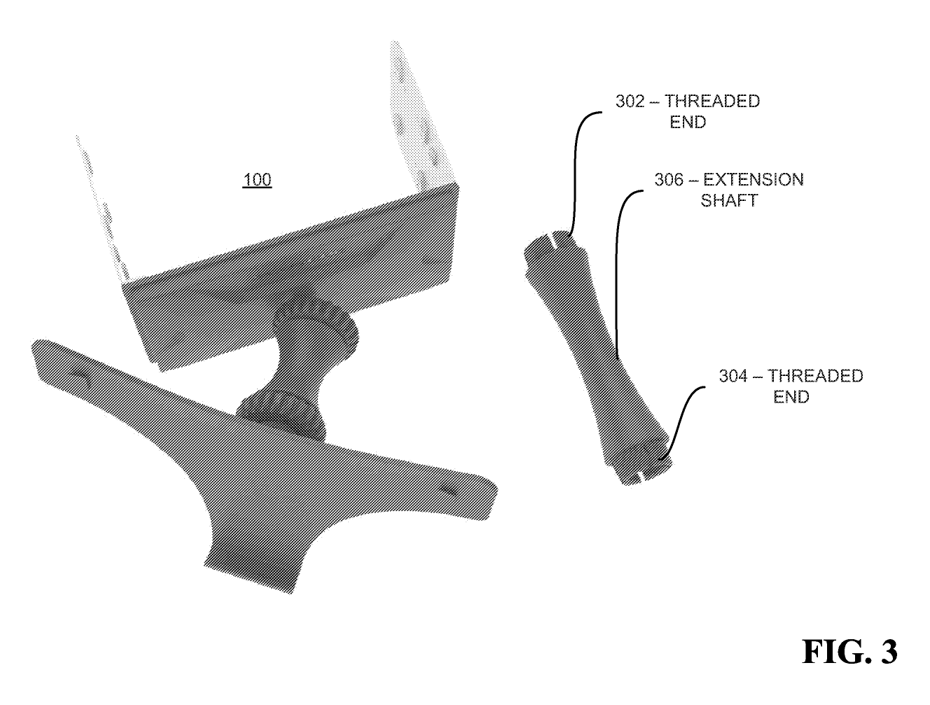

Referring to FIG. 2, the face plate 106 on the tablet mount 100 includes a adjustable support for the tablet, which in the illustrated embodiment includes a pair of spherical bearings 212, 214 onto which an extension shaft 206 may be attached using a pair of sockets in the extension shaft 206 and fix in position using a pair of locking couplers 202, 204 on corresponding ends of the extension shaft 206. The locking couplers 202, 204 allows the extension shaft 206 to be pivoted and rotated into many positions, and then locked down via a threaded tightening mechanism. Together, these elements form a pair of lockable ball joints. A second example of an extension shaft is seen in FIG. 3, which illustrates a longer extension shaft 306. Other lengths or types of extension shafts may be used, and may include an extension shaft that is bendable in and of itself for further adjustability of the support. Threaded ends 302 and 304 of the extension shaft, 306 may also be seen in FIG. 3, which are the type of threaded ends onto which the locking couplers 202, 204 may be attached after the spherical bearings 212, 214 have been inserted in respective ends of the extension shaft 306.

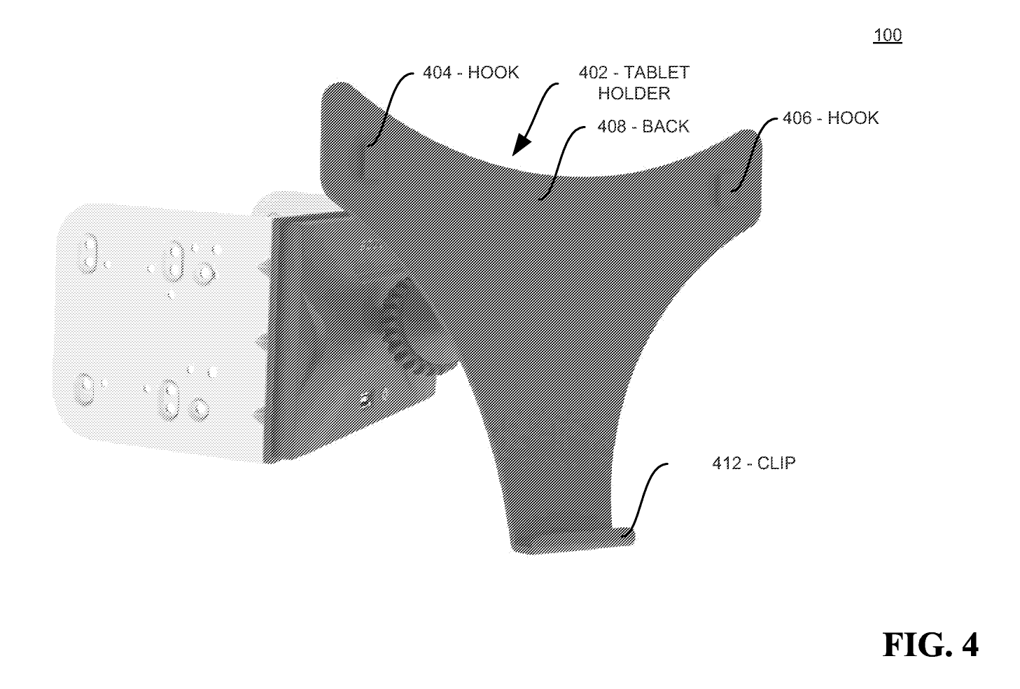

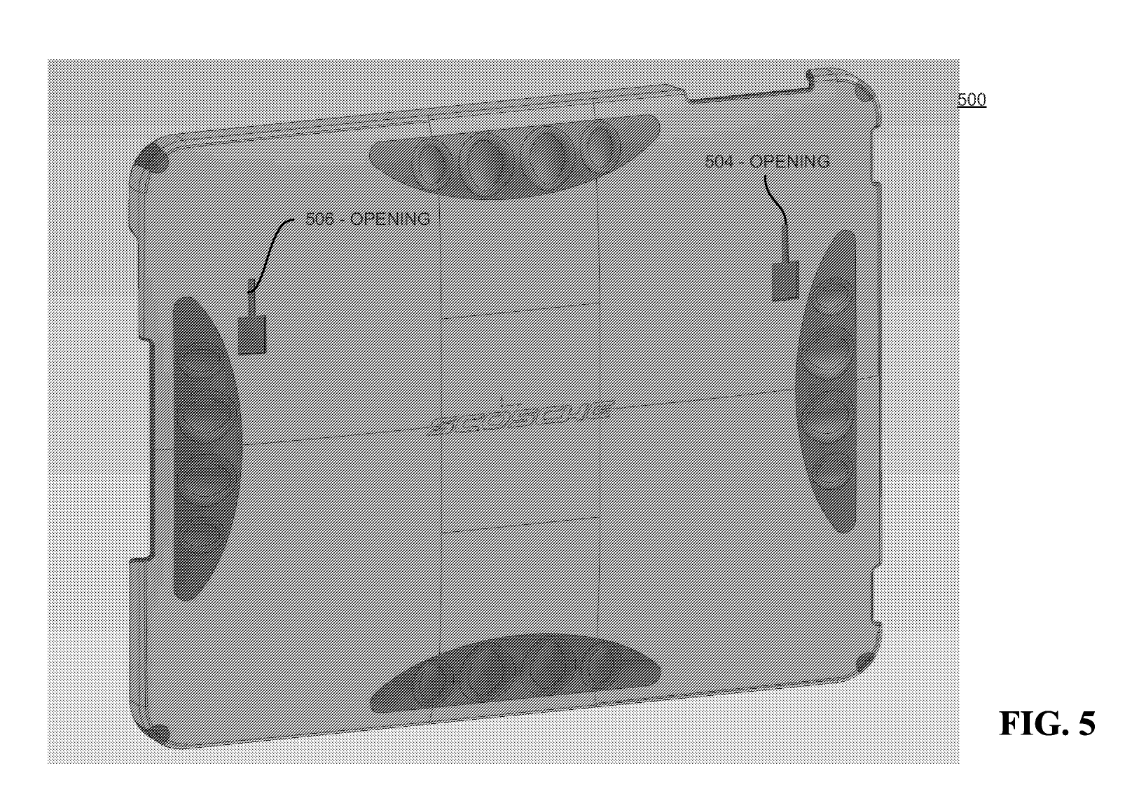

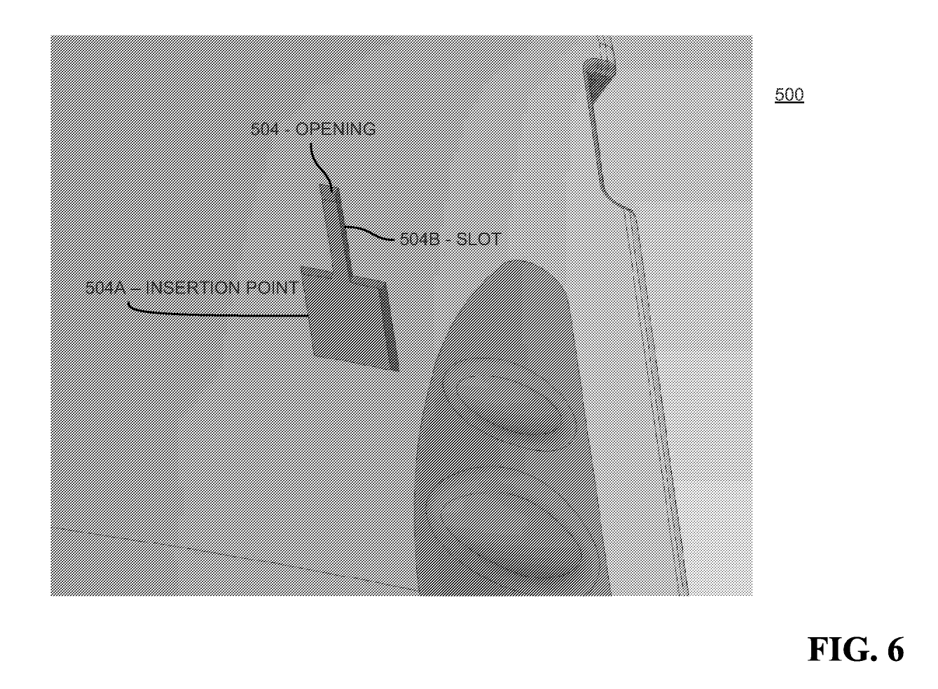

Referring to FIG. 4, the tablet may be attached to the tablet mount 100 via a tablet holder 402 on a support backing 408, which includes a clip 412 and a pair of hooks 404, 406 matched to retain the tablet, Also referring to FIG. 5, in one aspect, the tablet will be protected by a case 500 that includes a pair of shaped openings 504, 506 that respectively engages the pair of hooks 404, 406. Specifically, the pair of shaped openings 504, 506 are shaped in a manner to receive the insertion of the pair of hooks 404, 406. FIG. 6 offers a detailed view of one of the shaped openings 504 that illustrates an insertion point 504A into which one of the pair of hooks 404 is inserted and a slot 50413 that will engage the hook 404. Other suitable shapes for both pair of hooks 404, 406, and pair of shaped openings 504, 506 may be used.

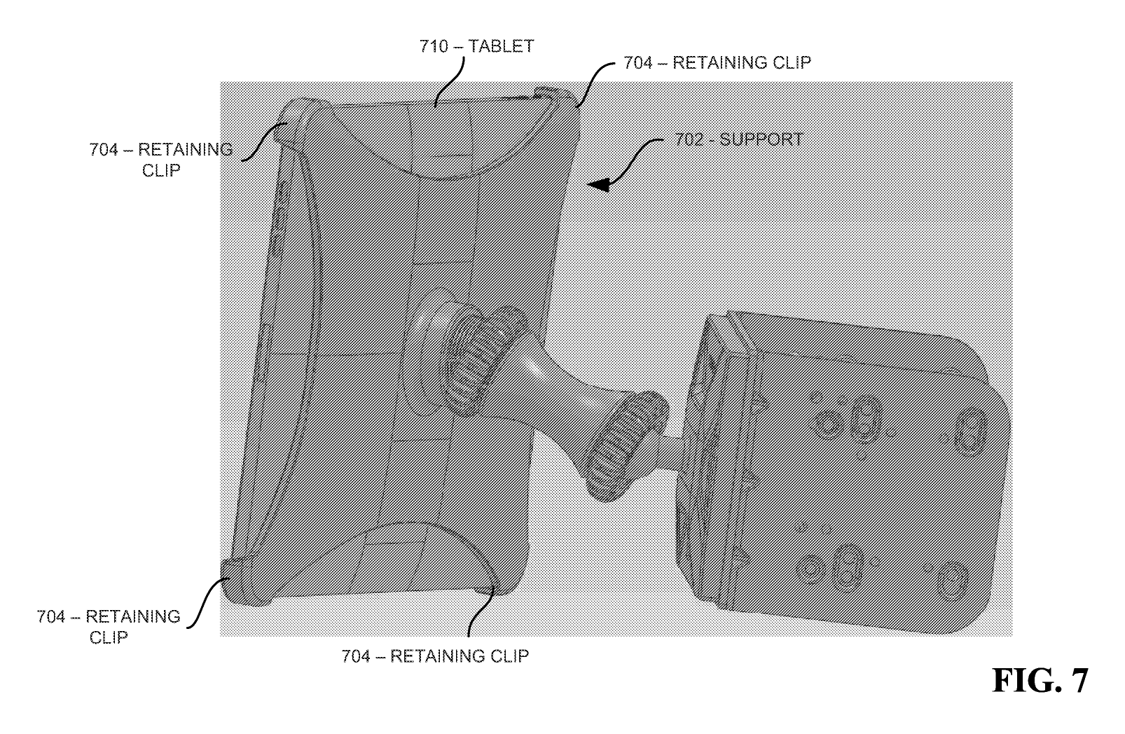

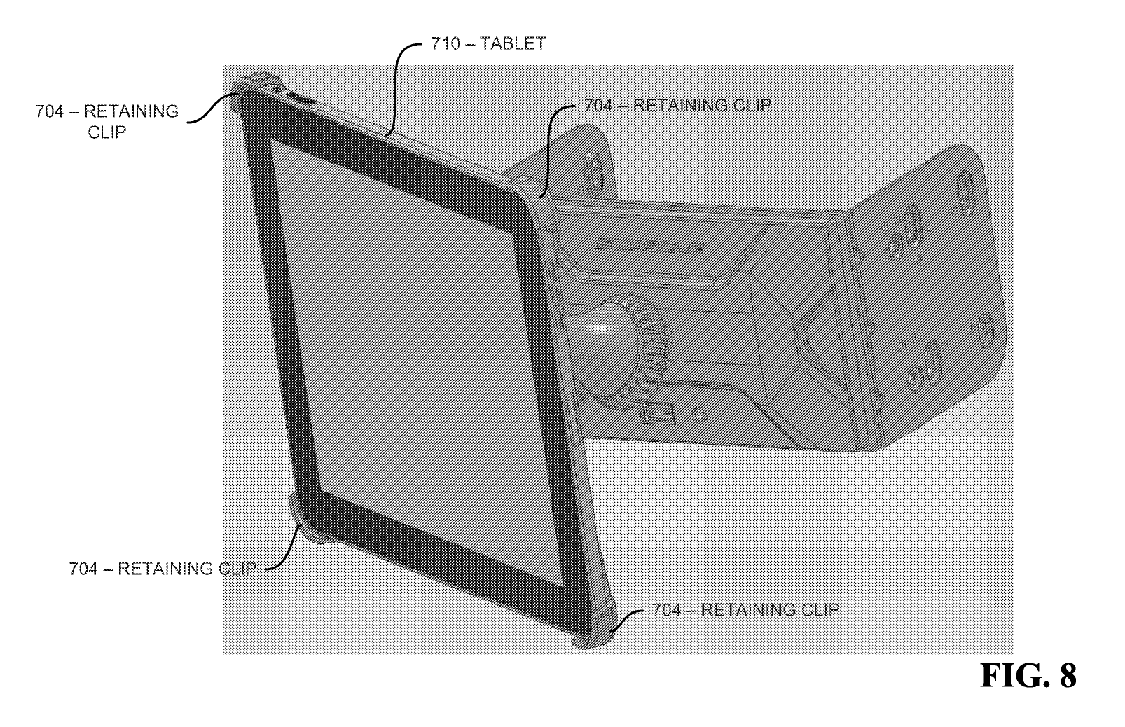

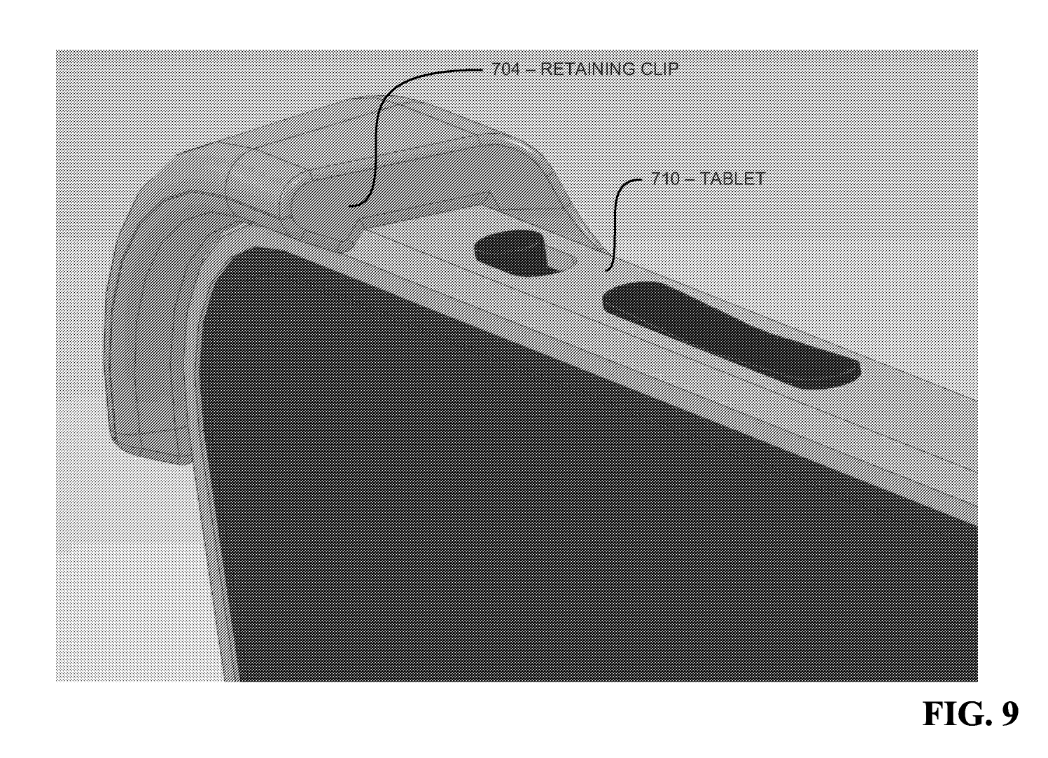

In other aspects, a tablet may be attached to the tablet mount 100 using other holding means that do not require the use of a matching case for the tablet. By way of example and not limitation, and referring to FIGS. 7 and 8, a tablet holder 702 includes a plurality of retaining clips 704 that retains a mobile device such as a tablet 710. The tablet holder 702 may be attached to the face plate 206 using the same ball joint/locking nut mechanism that is used for tablet holder 402. Thus, in one aspect of the disclosed tablet mounting system, various tablet holders may be used with the same face plate, customized for different devices or different tablet securing mechanisms. FIG. 9 illustrates a detailed view of the tablet 710 having been clipped into one of the plurality of retaining clips 704 to secure it to the tablet holder 702.

In other aspects, a hook-and-loop type fastener may be used, which would require a tablet be outfitted with a matching hook-and-loop type fastener.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more,” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A tablet mount, comprising:
an insert configured for mounting in a receptacle, the insert having two plates, each plate having a set of openings matched to a plurality of mounting holes, the two plates being parallel to each other;
a face plate coupled to the insert, the face plate comprising an adjustable support extending therefrom; and
a tablet holder coupled to the adjustable support.

2. The tablet mount of claim 1, wherein the adjustable support comprises:
a spherical bearing; and
a shaft comprising a socket coupled to the spherical bearing.

3. The tablet mount of claim 2, wherein the shaft comprises:
a threaded portion displaced at one end of the shaft, and
a locking coupler comprising matching threads configured to mate to the threaded portion, the locking coupler fixing the shaft in a position relative to the face plate when the matching threads are tightened against the threaded portion on the shaft.

4. The tablet mount of claim I, wherein the tablet holder comprises:
a support backing comprising:
a first retaining member configured to support a tablet computer; and
a second retaining member.

5. The tablet mount of claim 4, wherein the first retaining member is a clip.

6. The tablet mount of claim 4, wherein the second retaining member comprises at east one hook.

7. The tablet mount of claim 1, wherein the tablet holder comprises a plurality of retaining clips.

8. The tablet mount of claim 1, wherein the two plates are configured as double DIN-sized plates.

9. A method of mounting a tablet computer, the method comprising:
providing an insert configured for mounting in a receptacle, the insert having two plates, each plate having a set of openings matched to a plurality of mounting holes, the two plates being parallel to each other;
attaching a face plate to the insert, the face plate comprising an adjustable support extending therefrom; and
attaching a tablet holder to the adjustable support.

10. The method of claim 9, wherein the adjustable support comprises:
a spherical bearing; and
a shaft comprising a socket coupled to the spherical bearing.

11. The method of claim 10, wherein the shaft comprises:
a threaded portion displaced at one end of the shaft, and
a locking coupler comprising matching threads configured to mate to the threaded portion, the locking coupler fixing the shaft in a position relative to the face plate when the matching threads are tightened against the threaded portion on the shaft.

12. The method of claim 9, wherein the tablet holder comprises:
a support backing comprising:
a first retaining member configured to support a tablet computer; and
a second retaining member.

13. The method of claim 12, wherein the first retaining member is a clip.

14. The method of claim 12, wherein the second retaining member comprises at least one hook.

15. The method of claim 9, wherein the tablet holder comprises a plurality of retaining clips.

16. The method of claim 9, wherein the two plates are configured as double DIN-sized plates.

17. A tablet mount, comprising:
an insert configured for mounting in a receptacle, the insert having two plates, each plate having a set of openings matched to a plurality of mounting holes, the two plates being parallel to each other;
means for holding a tablet; and
a face plate coupled to the insert, the Ike plate comprising means for adjustably supporting the means for holding the tablet extending therefrom.
